(19) United States
(12) Patent Application Publication
(10) Pub. No.: US 2020/0137713 A1
(43) Pub. Date: Apr. 30, 2020

(54) METHOD AND SYSTEM FOR BEAM ASSISTED POSITIONING

(71) Applicant: Rohde & Schwarz GmbH & Co. KG, Munich (DE)

(72) Inventors: Jurgen SCHLIENZ, Poing (DE); Adrian CARDALDA-GARCIA, Munich (DE); Bledar KARAJANI, Munich (DE); Sandra MERKEL, Munich (DE)

(21) Appl. No.: 16/171,559

(22) Filed: Oct. 26, 2018

(51) Int. Cl. H04W 64/00; G01S 11/06; G01S 11/08; H04W 72/04; H04W 72/08; H04B 7/06

(52) U.S. Cl. CPC H04W 64/003; G01S 11/06; G01S 11/08; H04W 76/10; H04W 72/085; H04B 7/0695; H04W 72/046

(57) ABSTRACT

A method for determining a location of a communication device in a communication system is provided. The communication system comprises at least one transmission reception point, transmitting a plurality of beams. Especially, the method comprises establishing a connection between the communication device and the at least one transmission reception point, determining a transit time of messages between the at least one transmission reception point and the communication device, determining at least one strongest beam of the plurality of beams of the at least one transmission reception point, with regard to the communication device, and determining a location of the communication device, based upon the at least one transit time to the at least one transmission reception point and the at least one strongest beam of the at least one transmission reception point.

### TECHNICAL FIELD

The invention relates to determining the position of a mobile communication device within a communication system, especially within a communications network.

### BACKGROUND

In order to determine the position of a mobile communication device, a number of different approaches exist so far. A straightforward approach is that the mobile communication device determines its position itself using a satellite-based positioning system, such as GPS. This approach is disadvantageous, since it requires additional hardware on the side of the mobile communication device, and also requires additional transmission resources for transmitting the positioning information to the communication network side.

Moreover, the document WO 2017/164925 A1 shows a positioning system, which uses the information of the direction of different transmission beams of a base station. The mobile device determines which beam it is connected to and determines its position from the known position of the base station and information regarding the orientation of the beam. According to this document though, a great number of additional pieces of information is used for determining the position of the mobile device, for example the orientation of the device antenna, the beam pointing angle as well in elevation as in azimuth, etc. This results in a very high computational complexity on the mobile side.

Accordingly, there is a need to provide a method and system for determining a location of a communication device in a communication system, which only require minimal hardware and computational complexity on the mobile side.

### SOME EXAMPLE EMBODIMENTS

Embodiments of the present invention advantageously address the foregoing requirements and needs, as well as others, by providing a method and system for determining a location of a communication device in a communication system, which only require minimal hardware and computational complexity on the mobile side.

According to a first aspect of the invention, a method for determining a location of a communication device in a communication system is provided. The communication system comprises at least one transmission reception point, transmitting a plurality of beams. Especially, the method comprises establishing a connection between the communication device and the at least one transmission reception point, determining a transit time of messages between the at least one transmission reception point and the communication device, determining at least one strongest beam of the plurality of beams of the at least one transmission reception point, with regard to the communication device, and determining a location of the communication device, based upon the at least one transit time to the at least one transmission reception point and the at least one strongest beam of the at least one transmission reception point. It is therefore possible to keep the necessary hardware on the mobile communication device side to a minimum. Also, the computational complexity is very low.

Advantageously and preferably, the method comprises determining at least two strongest beams of the at least one transmission reception point, with regard to the communication device, and determining a location of the communication device based upon the at least two strongest beams of the at least one transmission reception point. This allows for an increase in accuracy of the location determining.

Further advantageously and preferably, the method comprises determining transit times of messages between at least two transmission reception points and the communication device. The method further comprises determining a location of the communication device based upon the transit times to the at least two transmission reception points and the at least one strongest beam of the at least two transmission reception points. This also allows for an increase in accuracy of the positioning.

According to a second aspect of the invention, a communication system, comprising a communication device and at least one transmission reception point is provided. The communication system is adapted to establish a connection between the communication device and the at least one transmission reception point, determine a transit time of messages between the at least one transmission reception point and the communication device, determine at least one strongest beam of the plurality of beams of the at least one transmission reception point, with regard to the communication device and determine a location of the communication device based upon the at least one transit time to the at least one transmission reception point and the at least one strongest beam of the at least one transmission reception point. It is therefore possible to keep the necessary hardware on the mobile communication device side to a minimum. Also, the computational complexity is very low.

Advantageously, the system is adapted to determine at least two strongest beams of the at least one transmission reception point with regard to the communication device and determine the location of the communication device based upon the at least two strongest beams of the at least one transmission reception point. This allows for a further increase in location finding accuracy.

Further advantageously and preferably, the communication system comprises at least two transmission reception points. The system is then adapted to determine the transit times of messages between the at least two transmission reception points and the communication device, and to determine the location of the communication device based upon the transit times to the at least two transmission reception points and the at least one strongest beam of the at least two transmission reception points. This also allows for a further increase of location determining accuracy.

Preferably, the communication system moreover comprises a location server, which is adapted to determine the transit time of messages between the at least one transmission reception point and the communication device and/or determine the at least one strongest beam of the plurality of beams of the at least one transmission reception point with regard to the communication device, and/or determine the location of the communication device based upon the at least one transit time to the at least one transmission reception point and the at least one strongest beam of the at least one transmission reception point. By using a dedicated location server, the hardware complexity of the mobile communication device can be kept at a minimum.

Advantageously and preferably, this location server may be located within the transmission reception point, or within a base station, or at a separate side. This allows for a very flexible construction of the communication system.

Advantageously and preferably, the location server comprises a time determiner, which is adapted to determine the transit time of messages between the at least one transmission reception point and the communication device. This allows for a very accurate determining of the transit time.

Further advantageously and preferably, the communication system comprises at least two transmission reception points. The time determiner is then adapted to determine the transit times of messages between the at least two transmission reception points and the communication device. This allows for especially accurate location determining.

In a further advantageous and preferred embodiment, the location server comprises a beam determiner, which is adapted to determine the at least one strongest beam of the plurality of beams of the at least one transmission reception point, with regard to the communication device. This allows for keeping the hardware in the mobile communication device as simple as possible.

Advantageously and preferably, the beam determiner is adapted to determine at least two strongest beams of the plurality of beams of the at least one transmission reception point, with regard to the communication device. This allows for a further increase of location accuracy.

Preferably, the location server additionally comprises a position determiner, which is adapted to determine the location of the communication device based upon the at least one transit time to the at least one transmission reception point and the at least one strongest beam of the at least one transmission reception point. This further allows to keep the hardware within the communication device as simple as possible.

Preferably, the position determiner comprises a direction determiner, which is adapted to determine an angle between the communication device and each of the at least one transmission reception points, based upon the at least one strongest beam of the at least one transmission reception point. Additionally, or alternatively, the position determiner comprises a distance determiner, which is adapted to determine a distance to each of the at least one transmission reception points, based upon the transit time to the at least one transmission reception point. Additionally, or alternatively, the position determiner is adapted to determine the position of the communication device based upon the angle between the communication device and each of the at least one transmission reception points and the distance to each of the at least one transmission reception points. This also allows for keeping the hardware within the communication device as simple as possible.

Preferably, the communication system comprises at least two transmission reception points. In this case, the position determiner advantageously comprises a triangulator, which is adapted to triangulate the position of the communication device based upon the angles between the communication device and each of the at least two transmission reception points and the distance to each of the at least two transmission reception points. This allows for an especially accurate determining of the position of the communication device.

According to a third aspect of the invention, a computer program with program code is provided. The program code serves the purpose of performing the method according to the first aspect of the invention, when the computer program runs on a computer. This allows for a very simple mobile communication device side construction and also for a very low computational complexity on this side.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

Exemplary embodiments of the invention are now further explained by way of example only with respect to the drawings, in which:

FIG. 1 shows a first embodiment of the communication system of the second aspect of the invention;

FIG. 2 shows a detail of a second embodiment of the communication system according to the second aspect of the invention;

FIG. 3 shows a detail of a third embodiment of the communication system according to the second aspect of the invention;

FIG. 4 shows a detail of a fourth embodiment of the communication system according to the second aspect of the invention;

FIG. 5 shows a detail of a fifth embodiment of the communication system according to the second aspect of the invention;

FIG. 6 shows an exemplary method for aligning a transmission and reception timing of a mobile communication device, and

FIG. 7 shows an embodiment of the method according to the first aspect of the invention in a flow diagram.

### DETAILED DESCRIPTION

A method and system for determining a location of a communication device in a communication system, which only require minimal hardware and computational complexity on the mobile side, are described. In the following description, for the purposes of explanation, numerous specific details are set forth in order to provide a thorough understanding of the invention. It is apparent, however, that the invention may be practiced without these specific details or with an equivalent arrangement. In other instances, well-known structures and devices are shown in block diagram form in order to avoid unnecessarily obscuring the invention.

A processor, unit, module or component (as referred to herein) may be composed of software component(s), which are stored in a memory or other computer-readable storage medium, and executed by one or more processors or CPUs of the respective devices. A module or unit may alternatively be composed of hardware component(s) or firmware component(s), or a combination of hardware, firmware and/or software components. Further, with respect to the various example embodiments described herein, while certain of the functions are described as being performed by certain components or modules (or combinations thereof), such descriptions are provided as examples and are thus not intended to be limiting. Accordingly, any such functions may be envisioned as being performed by other components or modules (or combinations thereof), without departing from the spirit and general scope of the present invention. Moreover, the methods, processes and approaches described herein may be processor-implemented using processing circuitry that may comprise one or more microprocessors, application specific integrated circuits (ASICs), field programmable gate arrays (FPGAs), or other devices operable to be configured or programmed to implement the systems and/or methods described herein. For implementation on such devices that are operable to execute software instructions, the flow diagrams and methods described herein may be implemented in processor instructions stored in a computer-readable medium, such as executable software stored in a computer memory store.

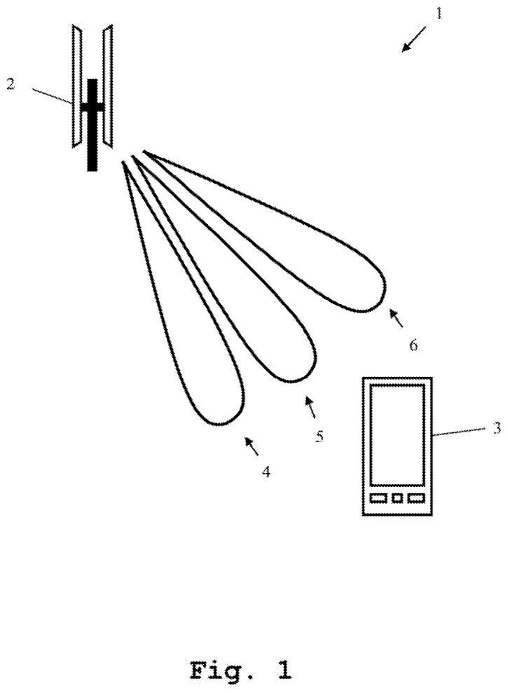

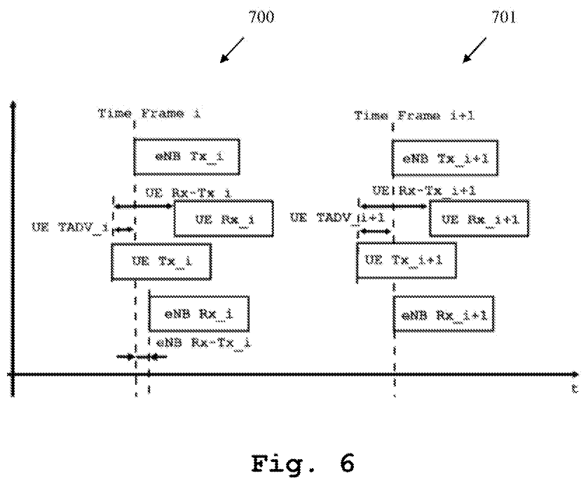

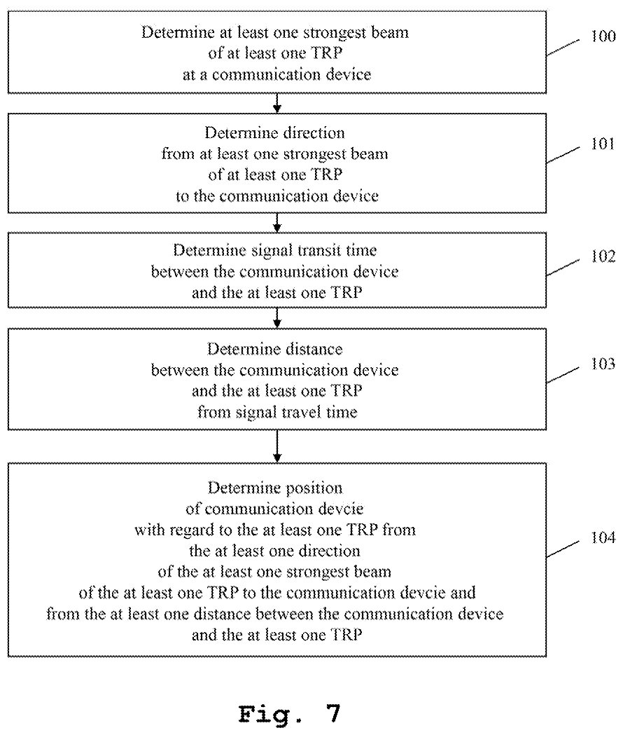

First, we demonstrate the construction and function of different embodiments of the inventive communication system along FIGS. 1-5. With regard to FIG. 6, a detail of a timing alignment of transmission and reception within a mobile communication device is shown. Finally, with regard to FIG. 7, the function of an embodiment of the inventive method according to the first aspect of the invention is shown. Similar entities and reference numbers in different figures have been partially omitted.

Reference will now be made in detail to the preferred embodiments of the present invention, examples of which are illustrated in the accompanying drawings. However, the following embodiments of the present invention may be variously modified and the range of the present invention is not limited by the following embodiments.

### First Embodiment

In FIG. 1, a first embodiment of the communication system 1 according to the second aspect of the invention is shown. The communication system 1 comprises a transmission reception point 2 and a communication device 3. The transmission reception point 2 can be a base station adapted to send out a plurality of beams, especially a 5G base station adapted to send out a plurality of beams. Also the transmission reception point 2 can be adapted to receive through a plurality of beams. A base station according any other appropriate communication standard, e.g. 4G, etc. is also possible.

The transmission reception point 2 of FIG. 1 transmits and receives using a number of beams 4, 5, 6. Here a number of three beams 4-6 is depicted, this is though not to be understood as limiting. Any number of beams can be used. The mobile communication device 3 receives the signal of at least one of the beams 4, 5, 6. In order to determine the position of the mobile communication device 3, the available information regarding the orientation of the beams 4, 5, 6 as well as the location of the transmission reception point 2 can be used. Moreover, a transit time of messages between the transmission reception point 2 and the communication device 3 can be used. Especially, from the orientation of the beams 4-6, a direction of the communication device 3 can be determined. From the transit times of messages, a distance between the transmission reception point 2 and the communication device 3 can be determined.

### Second Embodiment

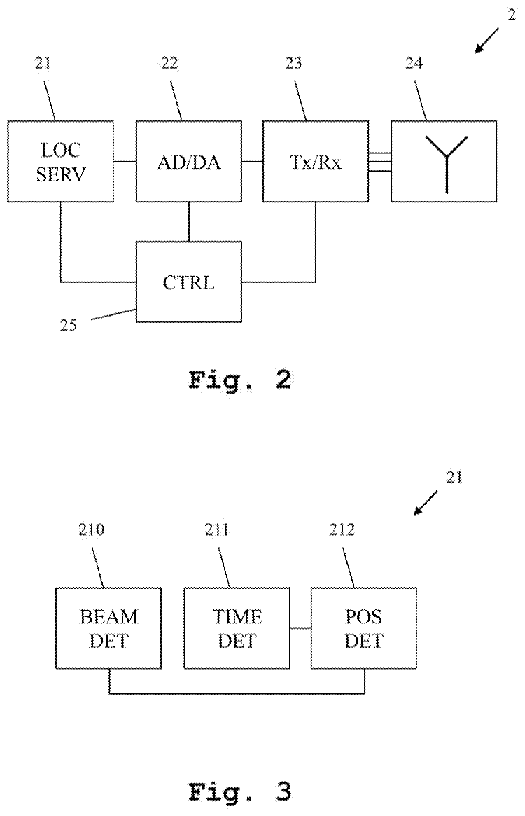

In FIG. 2, a detail of a second embodiment of the communication system of the second aspect of the invention is shown. Here, only the inner workings of the transmission reception point 2 of FIG. 1 are shown. Here, the location determining is performed at the location of the transmission reception point 2, especially within a location server 21. It should be pointed out that the location server 21 does not have to be part of the transmission reception point 2. It can be located completely off-site. Also, the location server could be positioned within the communication device 3.

The transmission reception point 2 comprises the mentioned location server 21, an analog-digital converter 22, connected to the location server 21, and a transceiver 23, which is connected to the analog-digital converter 22. Moreover, the transmission reception point 2 comprises an antenna 24, connected to the transceiver 23. All components except for the antenna 24 are moreover connected to a controller 25, which controls the operation of the transmission reception point 2.

It is important to note that although an analog-digital converter 22 is mentioned, the use of a digital-analog converter or a combined analog-digital and digital-analog converter is also possible. For a measurement direction of receiving signals through the antenna 24, a conversion from analog to digital is used, while for a transmission of signals through the antenna 24, a conversion from digital to analog is used.

It is important to note that only components relevant to the invention are shown here. Further components of the transmission reception point necessary for performing the communications function are not explicitly shown here.

The transmission reception point 2 establishes a communications connection to the communication device 3 of FIG. 1 by generating a digital baseband signal by the controller 25, handing this signal to the analog-digital converter 22, which converts it to an analog baseband signal, and modulating the analog baseband signal to a transmission signal by the transceiver 23. This transmission signal is then transmitted to the communication device 3 by use of the antenna 24. It is important to note that the antenna 24 in fact comprises a plurality of individual beam antennas or is an antenna array setup for generating a plurality of different beams. The controller 25 moreover is adapted to generate a different digital baseband signal for each of the beams, so that the mobile communication device 3 can determine, which beam it is connected to.

By using the information regarding which beam the mobile communication device 3 is connected to and the angle of the beam, the direction of the mobile communication device 3 with regard to the transmission reception point 2 can be determined. Additionally, using a transit time of the signal between the transmission reception point 2 and the communication device 3, the distance between the transmission reception point 2 and the communication device 3 can be determined. The information regarding which beam the communication device is connected to can then either be determined by the transmission reception point 2 or by the communication deice, in which case it is transmitted to the transmission reception point

These determinations are made by the location server 21, which is further explained with regard to FIG. 3-FIG. 5.

### Third Embodiment

In FIG. 3, a detail of a third embodiment of the communication system of the second aspect of the invention is shown. Here, the inner workings of the location server 21 of FIG. 2 are depicted. Especially, the location server comprises a beam determiner 210 connected to a position determiner 212 and a time determiner 211 connected to the position determiner 212. The beam determiner 210 receives information from the controller 25 with regard to which of the beams the mobile communication device 3 is connected to. Advantageously, the beam determiner 210 determines a strongest beam with regard to the communication device 3. In case only the strongest beam is determined, the direction of the communication device 3 is assumed to be identical to the direction of this strongest beam. In order to increase the accuracy, a plurality of strongest beams can be determined. In this case, an interpolation between the strongest beams based upon the power of the individual strongest beams can be performed. The direction of the communication device 3 is determined by this interpolation.

The time determiner 211 determines the transit time of messages between the communication device 3 and the transmission reception point 2. Especially, this can be done based upon a round-trip time of a communication between the communication device 3 and the transmission reception point 2. The transit time then is half this round-trip time. With regard to this timing information, it is referred to later elaborations regarding FIG. 6.

Based upon this beam information and time information, the position determiner 212 determines the position of the communication device 3. Especially, it determines the direction of the communication device 3 with regard to the transmission reception point 2 based upon the beam information provided by the beam determiner 210. Then the position determiner 212 determines the distance towards the transmission reception point based upon the transit time determined by the time determiner 211.

Advantageously, not only the information of a single transmission reception point is used for the location determining. In case of more than one transmission reception point being used, the location server 21 is provided with beam information and time information by the further transmission reception points, so that the beam determiner 210 can determine the strongest beam or strongest beams of all involved transmission reception points and the time determiner 211 can determine the transit time information between all involved transmission reception points and the communication device 3.

The position determiner 212 can then determine the position of the communication device 3 very accurately based upon the beam and time information of all involved transmission reception points. With regard to the detailed function of the position determiner, it is referred to the later elaborations regarding FIG. 5.

### Fourth Embodiment

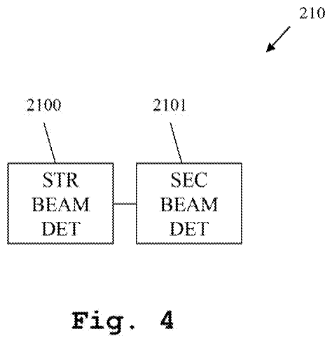

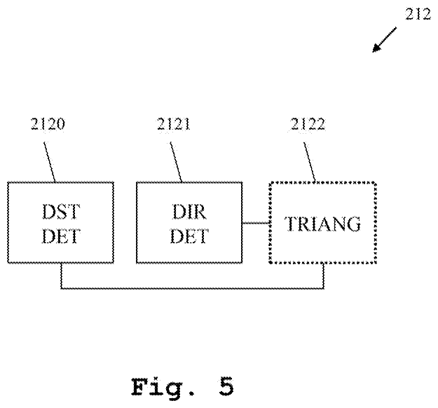

In FIG. 4, a further detail of a fourth embodiment of a communication system of the second aspect of the invention is shown. Here, inner workings of the beam determiner 210 of FIG. 3 are shown. The beam determiner 210 comprises a strongest beam determiner 2100 and a second strongest beam determiner 2101. The strongest beam determiner 2100 determines the strongest beam of the transmission reception point with regard to the communication device 3, while the second strongest beam determiner 2101 determines a second strongest beam of the transmission reception point with regard to the communication device 3. Advantageously, the beam determiner 210 can comprise further strongest beam determiners, for determining a third, fourth, fifth, etc. strongest beam of the transmission reception point 2.

It should be noted that when referring to a strongest beam of the transmission reception point 2 with regard to the communication device 3, a beam is meant, which is received by the communication device 3 with highest power, or a beam is meant, through which a signal of the communication device 3 is received with highest power.

### Fifth Embodiment

In FIG. 5, a further detail of a communication system of the third aspect of the invention is shown. In FIG. 5, especially the inner workings of the position determiner 212 of FIG. 3 are shown. The position determiner 212 here comprises a distance determiner 2120, which is connected to an optional triangulator 2122. Additionally, the position determiner 212 comprises a direction determiner 2121, which is also connected to the optional triangulator 2122.

The distance determiner 2120 uses the time information, especially the transit time of messages between the communication device 3 and the transmission reception point 2 provided by the time determiner 211 to determine a distance between the communication device 3 and each of the transmission reception points 2. This information is then optionally handed to the optional triangulator 2122.

Moreover, the direction determiner 2121 is adapted to determine the direction of the communication device 3 with regard to the transmission reception points based upon the beam information provided by the beam determiner 210 of FIG. 3. Especially, the direction with regard to several transmission reception points 2 can be determined.

If more than one transmission reception point is involved, the position determiner 212 comprises the triangulator 2122. The triangulator 2122 then performs a triangulation of the communication device 3 based upon the direction with regard to all involved transmission reception points and based upon the distance towards all involved transmission reception points 2.

In FIG. 6, some information regarding a timing adjustment of transmission and reception signals of a communication device 3 are given. In a first frame i, referred to by reference number 700, a transmission by a transmission reception point towards the communication device labelled eNB Tx_i is not time-synchronous with a reception of a signal eNB Rx_i by the transmission reception point. This is due to the fact that the communication device 3 can be at varying distance from the transmission reception point 2, leading to varying transit time.

For aligning the transmission and reception, a time difference between a reception of a signal by the communication device 3 and a transmission of a signal by the communication device 3 is determined. From this time difference, a time adjustment value TADV_i is determined. This time adjustment value is used to align the transmission and reception in the following frame i+1, also referred to as 701. As can be seen there, the transmission and reception by the transmission reception point now occur at the same time. When this is achieved, it is especially simple to determine the transit time of messages between the transmission reception point and the communication device, allowing for an especially accurate distance determining.

### Sixth Embodiment

In FIG. 7, finally, a communication method according to the first aspect of the invention is shown in a flow diagram. In a first step 100, at least one strongest beam of at least one transmission reception point with regard to a communication device is determined. In a second step 101, a direction of the communication device is determined based upon the beam information determined in step 100. In a third step 102, a transit time between the communication device and the at least one transmission reception point is determined. In a fourth step 103, a distance between the at least one transmission reception point and the communication device is determined based upon the transit time. In a final fifth step 104, the position of the communication device is determined based upon the direction and distance determined in the earlier steps.

It is important to note that the method according to the first aspect of the invention very closely corresponds to the communication system of the second aspect of the invention, and therefore all features described with regard to any of the aspects are also relevant to all other aspects of the invention.

The embodiments of the present invention can be implemented by hardware, software, or any combination thereof. Various embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

Various embodiments of the present invention may also be implemented in the form of software modules, processes, functions, or the like which perform the features or operations described above. Software code can be stored in a memory unit so that it can be executed by a processor. The memory unit may be located inside or outside the processor and can communicate date with the processor through a variety of known means.

The invention is not limited to the examples and especially not to a specific number of transmission reception points or beams within any of the transmission reception points. The invention discussed above can be applied to many communication systems and many different communication standards. The characteristics of the exemplary embodiments can be used in any advantageous combination.

Although the present invention and its advantages have been described in detail, it should be understood, that various changes, substitutions and alterations can be made herein without departing from the spirit and scope of the invention as defined by the appended claims.

1. A method for determining a location of a communication device in a communication system, the method comprising:
establishing a connection between the communication device and at least one transmission reception point of the communication system;
determining, by a location server, at least one transit time of messages between the at least one transmission reception point and the communication device, wherein the location server is located within the at least one transmission reception point;
determining at least one strongest beam of a plurality of beams of the at least one transmission reception point, with regard to the communication device; and
determining, by the location server, a location of the communication device based upon the at least one transit time to the at least one transmission reception point and the at least one strongest beam of the at least one transmission reception point.

2. The method of claim 1, wherein the method comprises:
determining at least two strongest beams of the plurality of beams of the at least one transmission reception point, with regard to the communication device; and
determining the location of the communication device based upon the at least two strongest beams of the at least one transmission reception point.

3. The method of claim 1, wherein the method comprises:
determining transit times of messages between at least two transmission reception points and the communication device; and
determining the location of the communication device based upon the transit times to the at least two transmission reception points and the at least one strongest beam of the at least two transmission reception points.

4. A communication system comprising:
a communication device;
at least one transmission reception point; and
a location server located within the at least one transmission reception point; and
wherein the communication system is adapted to (i) establish a connection between the communication device and the at least one transmission reception point, (ii) determine at least one transit time of messages between the at least one transmission reception point and the communication device, (iii) determine at least one strongest beam of a plurality of beams of the at least one transmission reception point, with regard to the communication device, and (iv) determine a location of the communication device based upon the at least one transit time to the at least one transmission reception point and the at least one strongest beam of the at least one transmission reception point.

5. The communication system of claim 4, wherein the communication system is adapted to:
determine at least two strongest beams of the plurality of beams of the at least one transmission reception point, with regard to the communication device; and
determine the location of the communication device based upon the at least two strongest beams of the at least one transmission reception point.

6. The communication system of claim 4, wherein the communication system comprises:
at least two transmission reception points; and
wherein the communication system is adapted to determine transit times of messages between the at least two transmission reception points and the communication device, and determine the location of the communication device based upon the transit times to the at least two transmission reception points and the at least one strongest beam of the at least two transmission reception points.

7. The communication system of claim 4, wherein the location server is adapted to determine the at least one transit time of the messages between the at least one transmission reception point and the communication device, and/or to determine the at least one strongest beam of the plurality of beams of the at least one transmission reception point, with regard to the communication device, and/or to determine the location of the communication device based upon the at least one transit time to the at least one transmission reception point and the at least one strongest beam of the at least one transmission reception point.

8. The communication system of claim 7, wherein the location server comprises:
a time determiner adapted to determine the at least one transit time of the messages between the at least one transmission reception point and the communication device.

9. The communication system of claim 8, wherein the communication system comprises:
at least two transmission reception points; and
wherein the time determiner is adapted to determine the transit times of messages between the at least two transmission reception points and the communication device.

10. The communication system of claim 7, wherein the location server comprises:
a beam determiner adapted to determine the at least one strongest beam of the plurality of beams of the at least one transmission reception point, with regard to the communication device.

11. The communication system of claim 10, wherein the beam determiner is adapted to determine at least two strongest beams of the plurality of beams of the at least one transmission reception point, with regard to the communication device.

12. The communication system of claim 7, wherein the location server comprises:
a position determiner adapted to determine the location of the communication device based upon the at least one transit time to the at least one transmission reception point and the at least one strongest beam of the at least one transmission reception point.

13. The communication system of claim 12, wherein:
the position determiner comprises a direction determiner adapted to determine an angle between the communication device and each of the at least one transmission reception points, based upon the at least one strongest beam of the at least one transmission reception point; and/or
the position determiner comprises a distance determiner adapted to determine a distance to each of the at least one transmission reception points, based upon the at least one transit time to the at least one transmission reception point; and/or
the position determiner is adapted to determine the position of the communication device based upon the angle between the communication device and each of the at least one transmission reception points and the distance to each of the at least one transmission reception points.

14. The communication system of claim 12, wherein communication system comprises:
at least two transmission reception points; and
wherein the position determiner comprises a triangulator adapted to triangulate the position of the communication device based upon angles between the communication device and each of the at least two transmission reception points and a distance to each of the at least two transmission reception points.
